(19) United States
(12) Patent Application Publication
(10) Pub. No.: US 2026/0356470 A1
(43) Pub. Date: Nov. 12, 2026

(54) ADJUSTABLE STOPPER ASSEMBLY FOR AIRCRAFT UTILITY TRACK SYSTEM

(71) Applicant: Textron Innovations Inc., Providence, RI (US)

(72) Inventor: Steve Pothier, Blainville (CA)

(73) Assignee: Textron Innovations Inc., Providence, RI (US)

(21) Appl. No.: 19/205,686

(22) Filed: May 12, 2025

(51) Int. Cl. B64C 1/20

(52) U.S. Cl. CPC B64C 1/20

(57) ABSTRACT

One embodiment is an adjustable stopper assembly for an aircraft track including a stopper element having an opening therethrough, a slider positioned below the stopper element, the slider having a lug extending through the opening in the stopper element; and a lever positioned over the stopper. The lever is hingedly connected to the lug of the slider and configured to be rotated relative to a top of the stopper element between an open position in which the lever extends substantially perpendicularly to the top of the stopper element and a closed position in which the lever extends substantially parallel to top of the stopper element. Positioning the lever in the closed position locks the slider element into place relative to the aircraft track.

### TECHNICAL FIELD

This disclosure relates in general to the field of aircraft and, more particularly, though not exclusively, to adjustable stops for use in a utility track system in such aircraft.

### BACKGROUND

Various aircraft, including rotorcraft, may include one or more utility, or seat, track systems to which seats may be connected to enable the cabin of the aircraft to be quickl40y and easily reconfigured by translating the seats along the track systems and securing them at selected positions. Configuration of the cabin may be based on a mission the aircraft is being used to perform. For example, certain missions may require that seats be maintained in locations and positions that are clear of equipment or cargo disposed within the cabin. Physical stops and tiedown fittings are available for accomplishing this result; however, current solutions include stops or fittings that protrude above the surface of the tracks and/or require tools to reposition the stops or fittings.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIGS. 1A and 1B respectively illustrate a side plan view and a front plan view of an example rotorcraft in which embodiments described herein may be implemented;

FIG. 2 illustrates a portion of an interior of an aircraft cabin including a seat attached to a track assembly in accordance with features of embodiments described herein;

FIGS. 3A-3C illustrate more detailed views of a track of the track assembly of FIG. 2 in accordance with features of embodiments described herein;

FIGS. 4A and 4B illustrate a stopper assembly for use in connection with the track assembly of FIG. 2 in accordance with features of embodiments described herein;

FIGS. 5A-5D illustrate use of the stopper assembly of FIGS. 4A-4B in connection with the track assembly of FIG. 2 in accordance with features of embodiments described herein; and

FIGS. 6A and 6B illustrate an alternative stopper assembly and use thereof in connection with the track assembly of FIG. 2 in accordance with features of alternative embodiments described herein.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer’s specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of an aircraft relative to another component or component aspect(s). The term “aft” may refer to a spatial direction that is closer to a rear of an aircraft relative to another component or component aspect(s). The term “inboard” may refer to a location of a component that is within the fuselage of an aircraft and/or a spatial direction that is closer to or along a centerline of the aircraft (wherein the centerline runs between the front and the rear of the aircraft) or other point of reference relative to another component or component aspect. The term “outboard” may refer to a location of a component that is outside the fuselage of an aircraft and/or a spatial direction that is farther from the centerline of the aircraft or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying figures.

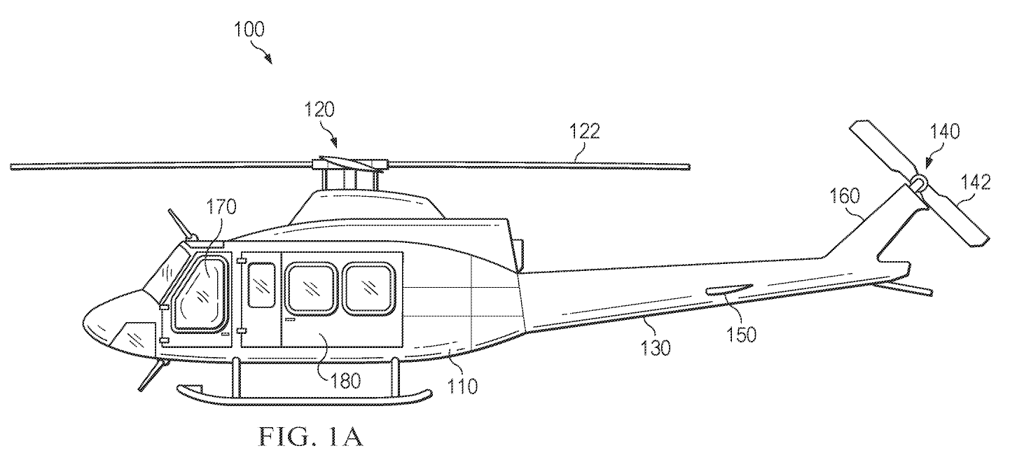

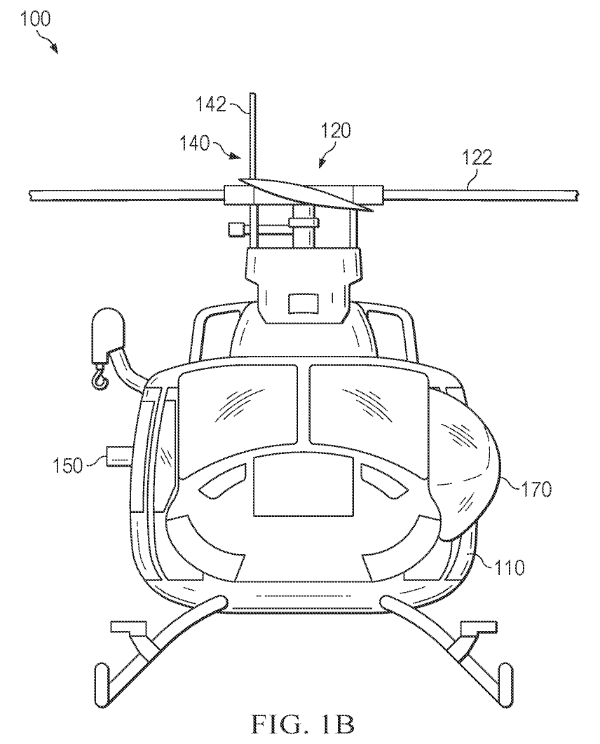

FIGS. 1A and 1B respectively illustrate side and front plan views of an example embodiment of a rotorcraft 100 in which embodiments described herein may be implemented. Rotorcraft 100 includes a fuselage 110, a rotor system (also alternatively referred to as a main rotor system) 120 comprising a plurality of rotating rotor blades 122, and an empennage 130. The fuselage 110 is the main body of the rotorcraft, which may include a cabin or cockpit for the crew, passengers, and/or cargo, and may also house certain mechanical and electrical components, such as one or more engines, transmission systems, and flight controls. The rotor system 120 is used to generate lift for the rotorcraft through rotation of rotor blades 122. For example, torque generated by the engine(s) causes the rotor blades 122 to rotate, which in turn generates lift. Moreover, the pitch of each rotor blade 122 can be adjusted in order to selectively control direction, thrust, and lift for the rotorcraft 100. The empennage 130 is the tail assembly of the rotorcraft. In the illustrated embodiment, the empennage 130 includes a tail rotor system 140, which may be used to provide anti-torque and/or directional control for the rotorcraft 100 using a plurality of rotating rotor blades 142. For example, torque generated by the engine(s) causes the rotor blades 142 to rotate, which in turn provides anti-torque and/or directional control. Blades 142 may provide thrust in the same direction as the rotation of blades 122 so as to counter the torque effect created by rotor system 120 and blades 122. Teachings of certain embodiments recognize that blades 142 may represent one example of a secondary rotor system. Other examples may include, but are not limited to, forward-thrust propellers (e.g., pusher propellers, tractor propellers, etc.), tail anti-torque propellers, ducted rotors, and ducted and mounted inside and/or outside the rotorcraft 100.

In the illustrated embodiment, the empennage 130 also includes a horizontal stabilizer 150 and a vertical stabilizer 160. In general, a stabilizer is an aerodynamic surface or airfoil that produces an aerodynamic lifting force (either positive or negative). For example, a stabilizer may be a fixed or adjustable structure with an airfoil shape and may also include one or more movable control surfaces. The primary purpose of a stabilizer is to improve stability about a particular axis (e.g., pitch or yaw stability), although a stabilizer can also provide other secondary aerodynamic benefits.

A horizontal stabilizer (e.g., horizontal stabilizer 150) is primarily used to provide stability in pitch, or longitudinal stability. For example, both the rotor and fuselage of a rotorcraft typically have an inherent negative stability derivative in pitch, and accordingly, a horizontal stabilizer may be used to neutralize pitch instability and improve the overall handling qualities of the rotorcraft. A horizontal stabilizer may also be used to generate lift for a rotorcraft, for example, to aid in climb or ascent. In some cases, a horizontal stabilizer may also include one or more movable control surfaces, such as an adjustable slat to aid in generating lift. The design of a horizontal stabilizer (e.g., airfoil shape, size, position on a rotorcraft, control surfaces) implicates numerous performance considerations and is often an extremely challenging aspect of aircraft design.

A vertical stabilizer (e.g., vertical stabilizer 160) is primarily used to provide stability in yaw, or directional stability. Although considerable yaw stability and control is often provided by a tail rotor, a vertical stabilizer may be used to supplement the performance of the tail rotor and/or reduce the performance requirements of the tail rotor. Accordingly, designing a vertical stabilizer and a tail rotor often implicates numerous interrelated performance considerations, particularly due to the interaction between their respective airflows. For example, a smaller vertical stabilizer may reduce the adverse effects on tail rotor efficiency but may adversely impact yaw stability and other design requirements (e.g., sideward flight performance, internal capacity for housing components within the vertical stabilizer). Accordingly, various performance considerations must be carefully balanced when designing a vertical stabilizer.

It will be recognized that various embodiments of horizontal and vertical stabilizers with designs that balance a variety of performance considerations to provide optimal performance may be provided. For example, certain embodiments of a horizontal stabilizer may be designed to provide strong aerodynamic performance (e.g., pitch stability and/or generating sufficient lift during climb or ascent) without using slats. Such a horizontal stabilizer may use a tailored airfoil design that is cambered and may form a concave slope on the top surface and/or a convex slope on the bottom surface. In some embodiments, the horizontal stabilizer may be mounted on the aft end of a rotorcraft. By obviating the need for slats, such a horizontal stabilizer design reduces complexity without a performance penalty, thus resulting in a more cost-efficient and reliable solution. Moreover, eliminating the slats similarly eliminates the need to provide anti-icing for the slats, thus providing a further reduction in complexity.

Moreover, certain embodiments of a vertical stabilizer may be designed to provide strong aerodynamic performance. Such a vertical stabilizer may use a tailored airfoil design that satisfies various design criteria, including strong aerodynamic performance (e.g., yaw stability, anti-torque control, minimal flow separation and drag). In some embodiments, for example, the vertical stabilizer may have a cambered airfoil shape that provides the requisite yaw stability and anti-torque control while also minimizing flow separation and drag. The cambered airfoil shape, for example, may enable the vertical stabilizer to provide a portion of the anti-torque required in forward flight (e.g., reducing the anti-torque requirements and power consumption of the tail rotor), and/or may also provide sufficient anti-torque to allow continued flight in the event of a tail rotor failure. The cambered airfoil shape may also enable the vertical stabilizer to provide sufficient aerodynamic side-force to offset the tail rotor thrust in forward flight, thus minimizing tail rotor flapping and cyclic loads and maximizing the fatigue life of components. Moreover, in some embodiments, the vertical stabilizer may have a blunt trailing edge (rather than a pointed trailing edge) in order to reduce the thickness tapering on the aft end without modifying the desired chord length, thus minimizing flow separation and drag while also reducing manufacturing complexity.

The particular embodiment of rotorcraft 100 illustrated in FIG. 1 includes a full-size bubble window 170 disposed on the co-pilot side of the cabin, or cockpit, portion of fuselage 110. As noted above, bubble window 170 enhances visibility on the side of the rotorcraft (which in the illustrated embodiment is the co-pilot side) on which it is located. Although not illustrated in FIGS. 1A and 1B, a bubble window similar or identical to bubble window 170 may be disposed on the pilot side (i.e., the opposite side) of the cockpit instead of or in addition to bubble window 170. A sliding door 180 is disposed on the side of fuselage 110 aft of bubble window 170. Although as shown in FIGS. 1A and 1B, bubble window 170 is a full-size bubble window, it is anticipated that embodiments described herein may be advantageously deployed in connection with other types of bubble windows.

It should be appreciated that rotorcraft 100 shown in FIGS. 1A and 1B is merely illustrative of a variety of aircraft that can be used with embodiments described throughout this disclosure. Other aircraft implementations can include, for example, fixed wing airplanes, hybrid aircraft, tiltrotor aircraft, unmanned aircraft, gyrocopters, a variety of helicopter configurations, and drones, among other examples.

Teachings of certain embodiments relating to rotor systems described herein may apply to rotor system 120 and/or other rotor systems, such as tiltrotor and helicopter rotor systems. It should be appreciated that teachings from rotorcraft 100 may apply to aircraft other than rotorcraft, such as airplanes and unmanned aircraft, to name a few examples. In some embodiments, rotorcraft 100 may include a variety of additional components not shown in FIGS. 1A and 1B. For example, rotor system 120 may include components such as a power train, drive shafts, a hub, a swatch plate, and pitch links.

In the example illustrated in FIGS. 1A and 1B, power may be provided from the engines to main rotor blades 122 and tail rotor blades 142 through a combination of drive shafts, gearboxes (e.g., transmission systems) and other components. In some example embodiments, engines provide power through a main rotor gearbox to a rotating mast in mechanical communication with rotor blades 122. In addition, a drive shaft may provide power to a secondary rotor gearbox (e.g., a 90-degree gearbox), which may transit power to rotor blades 142. In these example embodiments, main rotor gearbox may be proximate the fuselage 110, secondary rotor gearbox may be proximate the empennage 130, and drive shaft may be proximate the fuselage and/or the empennage (e.g., extending from the main rotor gearbox to secondary rotor gearbox).

A pilot may manipulate one or more pilot flight controls in order to achieve controlled aerodynamic flight of the rotorcraft 100. Inputs provided by the pilot-to-pilot flight controls may be transmitted mechanically and/or electronically (e.g., via a fly-by-wire flight control system) to flight control devices. Flight control devices may represent devices operative to change the flight characteristics of the aircraft. Examples of flight control devices on rotorcraft 100 may include a control system operable to change the positions of blades 122 and/or 142.

The components of rotor systems described herein may comprise any materials suitable for use with an aircraft rotor. For example, rotor blades and other components may comprise carbon fiber, fiberglass, or aluminum; and rotor masts and other components may comprise steel or titanium.

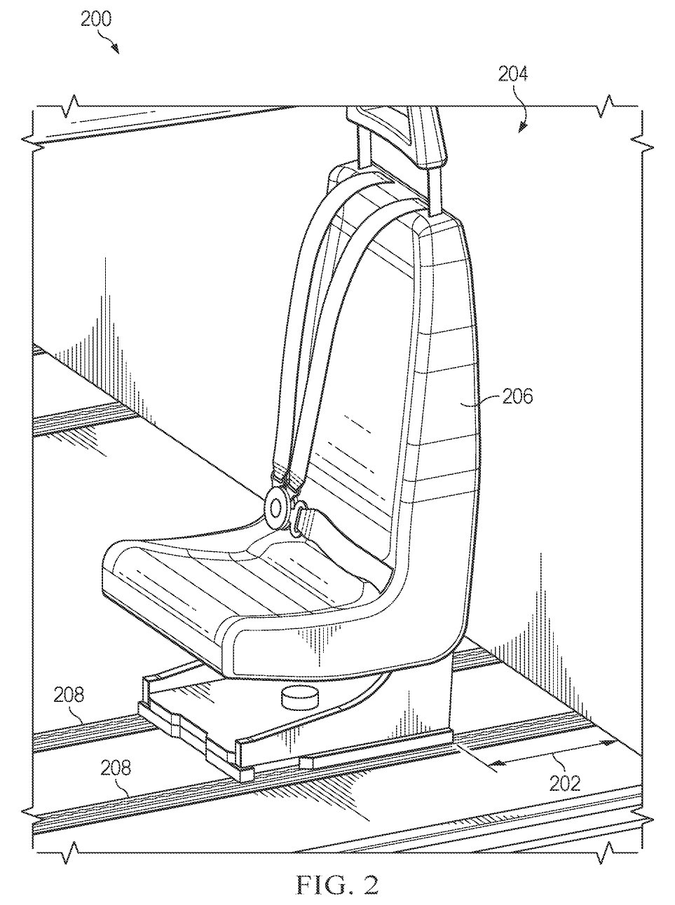

Aircraft, such as rotorcraft 100, may be used for a variety of different missions, each of which may require a different cabin configuration. For example, referring to FIG. 2, which illustrates a portion of an aircraft cabin 200, a mission may require that a minimum clearance 202 be provided between a cargo net 204 and a seat 206 to ensure that loads are not induced through inadvertent contact between cargo net 204 and seat 206. As shown in FIG. 2, seat 206 is connected to a set of tracks, or rails, 208, and may be translated along the length of rails and secured in a selected location along rails using stops or tie down fittings.

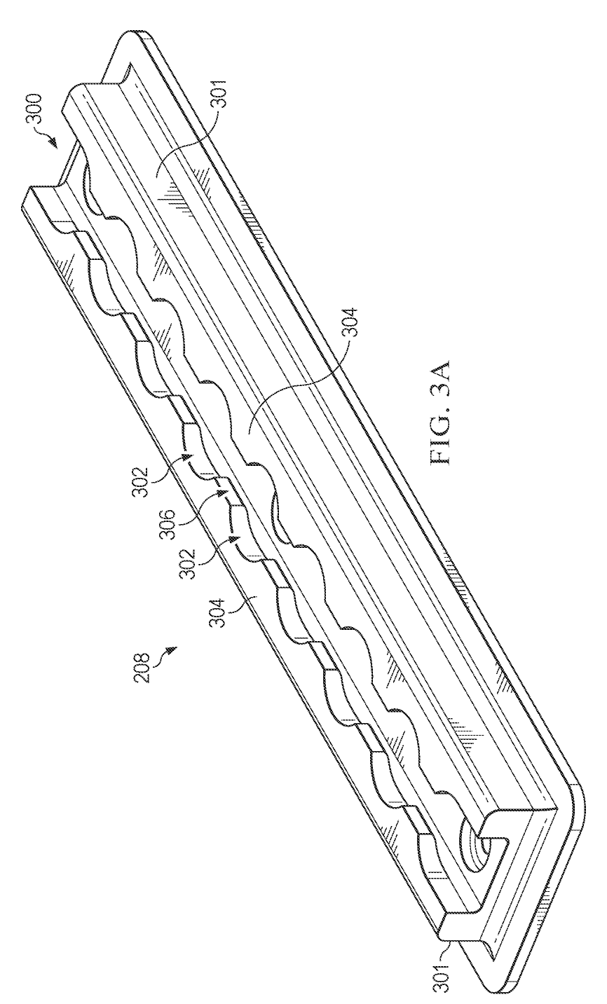

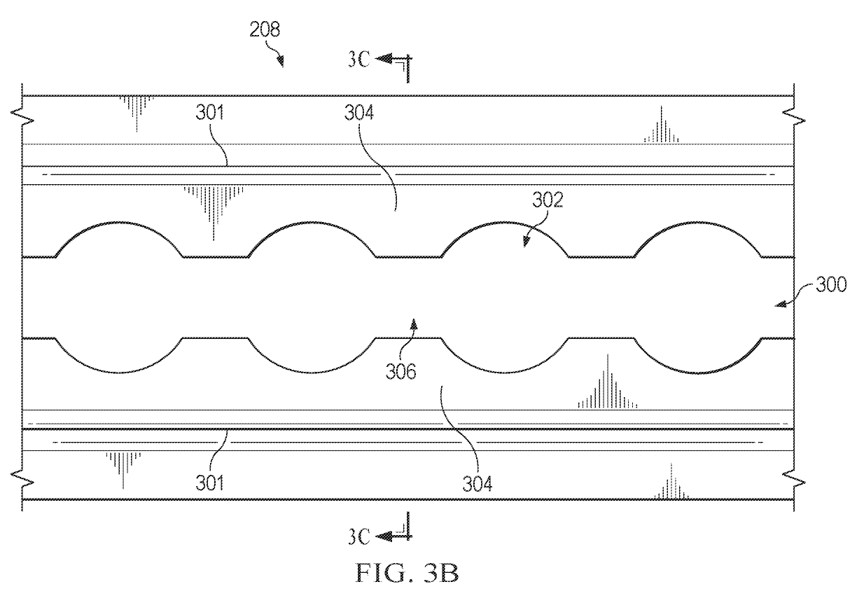

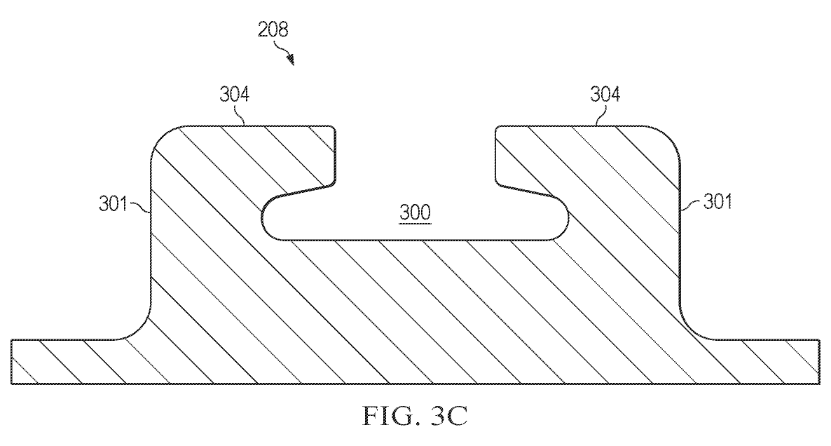

FIGS. 3A illustrates a perspective view of track 208. FIGS. 3B and 3C respectively illustrate top plan and cross-sectional views of track 308 shown in FIG. 3A. In the illustrated embodiment, track 208 is implemented in accordance with Military Standard MS33601 and may be commonly referred to as a Brownline or Douglas style track; however, it will be recognized that other types of tracks may be employed without departing from the spirit or scope of embodiments described herein. As shown in one or more of FIGS. 3A-3C, track 208 includes a slot 300 defined by side walls 301 and comprising a plurality of substantially circular openings 302 positioned along a length of track 208 separated by pairs of flanges 304 that extend inward from tops of side walls 301 other to define openings 306 between adjacent receptacles 302.

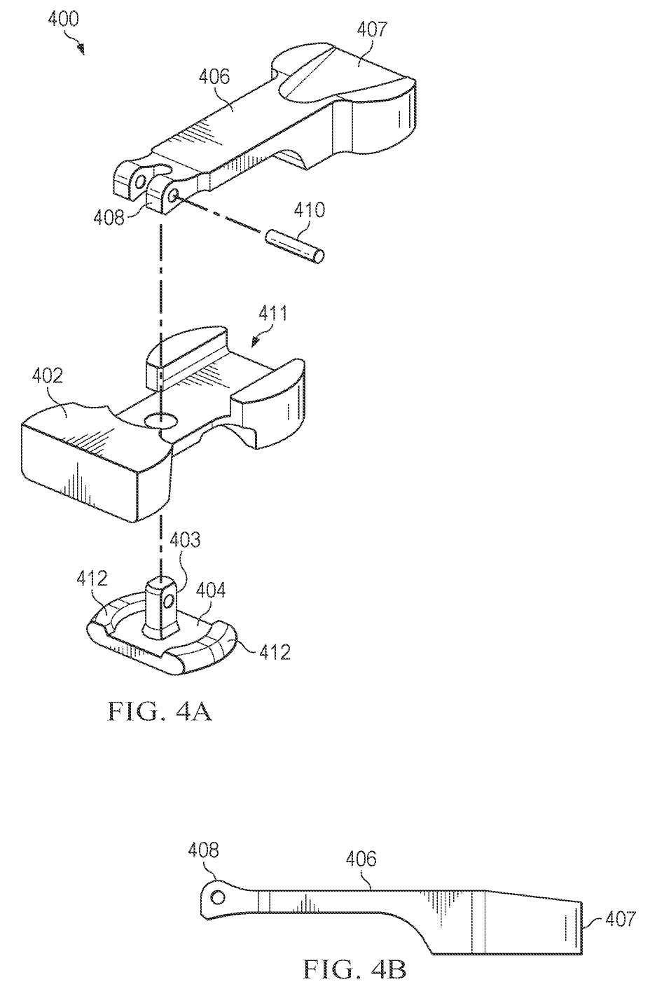

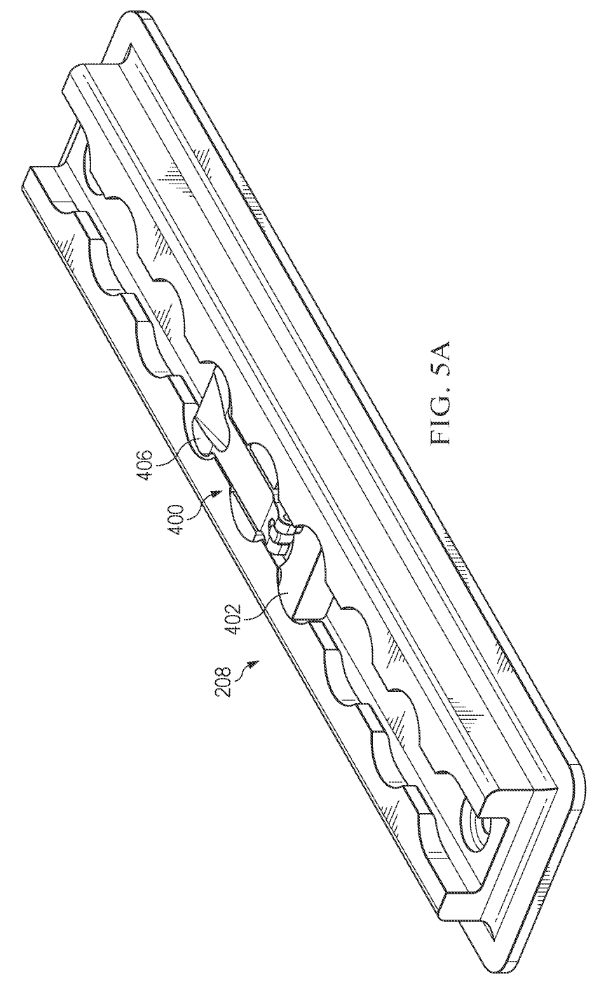

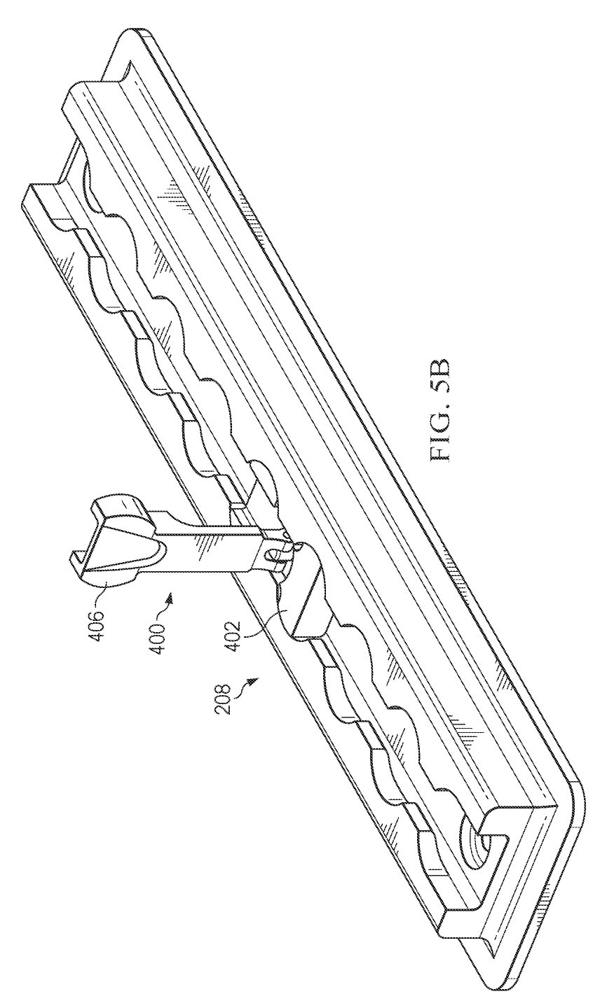

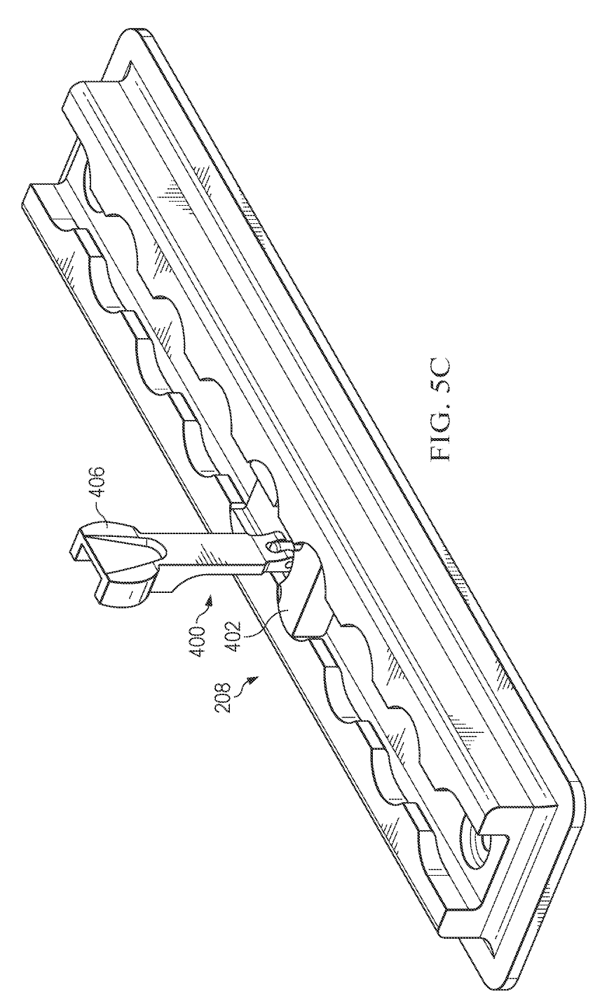

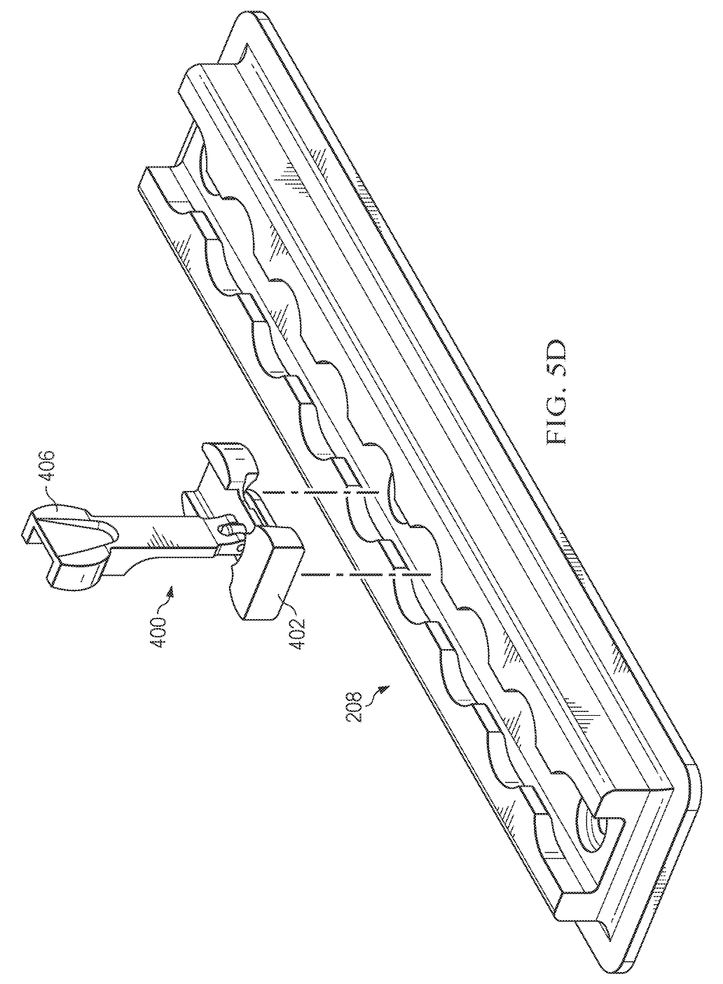

Referring now to FIG. 4A, illustrated therein is an exploded view of a stopper assembly 400 for use in connection with track 208 in accordance with features of certain embodiments described herein. As shown in FIG. 4A, stopper assembly 400 includes a stopper element 402 having an opening for receiving therethrough a lug 403 of a slider 404 when the slider is positioned below stopper element 402. A lever 406includes a handle 407at one end and a pair of lugs 408 designed to straddle lug 403 of slider 404 at the opposite end of lever 406. A spring pin 410is disposed through corresponding openings in lugs 403, 408, such that lever 406 is rotatable relative to the top surface of stopper element 402 between a closed, or locked, position (e.g., shown in FIG. 5A), in which lever 406 is lodged within a recess 411 of the top surface of stopper element 402 designed to accommodate a geometry of lever 406 and an open, or unlocked, position (e.g., shown in FIGS. 5B and 5C), in which lever 406 extends perpendicularly to the top surface of stopper element 402.

Stopper element 402, slider 404, and/or lever 406may be manufactured from metal or plastic, depending on the application. In particular embodiments, one or more of the stopper element 402, slider 404 and lever 406 are constructed from stainless steel in order to be strong enough to react seat or other utility accessory loads.

Additionally, as will also be described in greater detail below, rotation of lever 406 about a longitudinal axis thereof when lever is in the open position results in corresponding rotation of slider 404 about the same axis. For purposes that will be described in greater detail below, slider 404 includes tabs 412 on opposite sides thereof.

Referring now to FIG. 4B, illustrated therein is a side plan view of lever 406. As illustrated in FIG. 4B, lower surfaces of ends of lugs 408 are shaped to function as a cam for purposes that will be described in detail hereinbelow.

FIG. 5A illustrates stopper assembly 400 installed in track 208 with lever 406 in a closed, or locked, position. It will be recognized that outer mold line (OML) of stopper assembly 400 is designed to be accommodated within track 208 (i.e., within one or more adjacent receptacles 302 and intervening openings 306) with little to no play. As illustrated in FIG. 5A, when fully installed with lever 406 in the closed position, the top surface of stopper assembly 400 is substantially flush with the top of track 208, providing significant advantages over stopper assemblies that protrude from the top of track 208. When stopper assembly 400 is installed as shown in FIG. 5A, the shape of lugs 408 function cams to cause the lever 406 to snap into and remain in place within recess 411 (FIG. 4A). Additionally, top surfaces of tabs 412of slider 404 (not visible in FIG. 5A) are pressed against bottom surfaces of corresponding track flanges 304 when lever 406 is stowed as shown in FIG. 5A due to cam action of lugs 408, which causes slider 404 to be lifted when lever 406 is in the closed position.

FIG. 5B illustrates stopper assembly 400 installed in track 208 with lever 406 in an open, or unlocked, position such that lever 406 extends perpendicularly to top surface of stopper element 402, as well as track 208. Referring now also to FIG. 5C, turning, or rotating, lever 406 approximately 90 degrees around a longitudinal axis thereof results in a corresponding rotation of slider 404 (only partially visible in FIG. 5C) such that no portion of the top surface of lugs 412 of slider 404 engages the bottom surface of flanges such that the stopper assembly 400 can be pulled out of track 208, as illustrated in FIG. 5D. As illustrated above, stopper assembly 400 may be installed without the use of tools and, once installed, lies substantially flush with the top surface of track 208.

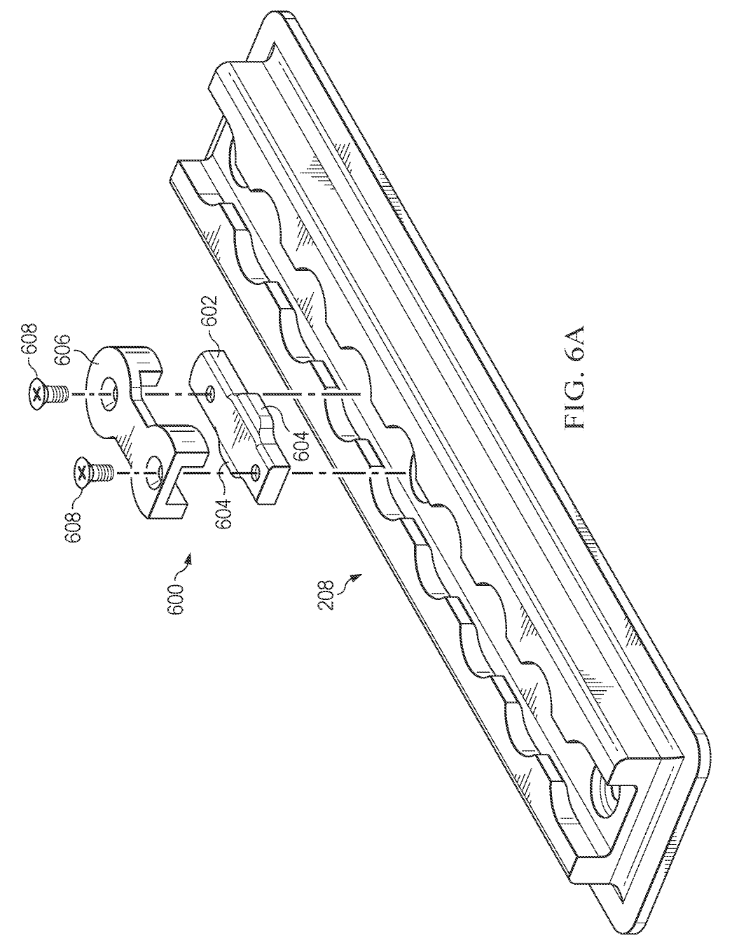

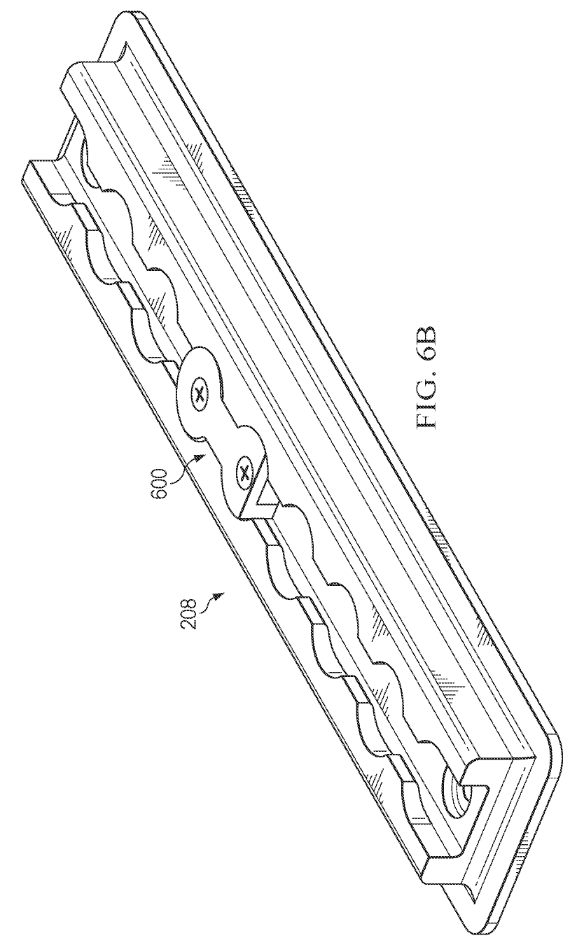

FIGS. 6A and 6B illustrate an alternative embodiment of a stopper assembly, designated in FIGS. 6A and 6B by a reference numeral 600. As best shown in FIG. 6A, which illustrates an exploded view of stopper assembly 600, stopper assembly 600 includes an interior portion 602 includes flanges 604 along side edges thereof. To install stopper assembly 600, interior portion 602 is inserted into the slot such that flanges 604 are positioned with one of receptacles 302 and then slid along slot until flanges 604 are disposed beneath flanges 304 in the in the selected location along track 208. An upper portion 606 is then overlaid on properly positioned interior portion 602 and securely attached to interior portion 602 e.g., via screws 608. Tightening of screws 608 causes top surfaces of flanges 604 to engage bottom surfaces of flanges 304, thereby securing the stopper assembly 600 in place within track 208. While this embodiment requires the use of a screwdriver to install and uninstall, once installed, the top surface of stopper assembly 600 lies flush with the top surface of track 208. In the embodiment illustrated in FIGS. 6A-6B, loads applied to the stopper assembly are not taken through clamping of flanges 604 to flanges 304 but through contact of the outer geometry of upper portion 604 with interior of seat track receptacles; the clamping only ensures that stopper assembly 600 remains within track 208.

Interior portion 602 and/or upper portion 604 may be manufactured from metal or plastic, depending on the application. In particular embodiments, one or both of the interior portion 602 and upper portion 604 are constructed from stainless steel in order to be strong enough to react seat or other utility accessory loads.

Embodiments described hereinabove provide a flush or substantially flush option for a track mounted stopper assembly. Clamping features of embodiments described herein remove slop between the track and the stopper assembly to avoid excessive rattling, which over time results in damage to both the track and the stopper assembly. Embodiments described herein may also be employed to attach and tie down equipment, accessories, systems, tools, etc. Mounting brackets could be designed using the embodiments described herein, enabling quick installation and removal.

Embodiments described herein do not rely solely on clamp friction to react to contact of seats or equipment. Loads induced by contact with the stopper assembly are reacted through stopper assembly larger diameter inside of seat track receptacle diameter. As previously noted, when locking/closing the lever, the cam shapes on the lever lugs ensure that the lever will remain locked as the cam goes over center. This design also assists in reducing and/or eliminating rattling of the lever. Embodiments described herein are not limited to floor-mounted racks and may be used on wall-mounted racks to tie down equipment and/or to limit mounting locations as desired.

Example 1 provides an adjustable stopper assembly for an aircraft track, the adjustable stopper assembly including a stopper element having an opening therethrough; a slider positioned below the stopper element, the slider having a lug extending through the opening in the stopper element; and a lever positioned over the stopper element, the lever hingedly connected to the lug of the slider and configured to be rotated relative to a top of the stopper element between an open position in which the lever extends substantially perpendicularly to the top of the stopper element and a closed position in which the lever extends substantially parallel to top of the stopper element; in which positioning the lever in the closed position locks the slider into place relative to the aircraft track.

Example 2 provides the adjustable stopper assembly of example 1, in which the lever includes a pair of lugs provided on one end thereof configured to straddle the lug of the slider.

Example 3 provides the adjustable stopper assembly of example 2, in which the lugs have holes therethrough for receiving a spring pin.

Example 4 provides the adjustable stopper assembly of example 2 or 3 in which the lever includes a handle on an end of the lever opposite the lugs thereof.

Example 5 provides the adjustable stopper assembly of any one of examples 2-4, in which distal ends of the lugs of the lever are configured to operate as cams for locking the lever in the closed position.

Example 6 provides the adjustable stopper assembly of any one of examples 1-5, in which the stopper element includes a recess for accommodating a portion of the lever when the lever is in the closed position.

Example 7 provides the adjustable stopper assembly of example 6, in which a top surface of the adjustable stopper assembly is substantially flush with a top of the aircraft track.

Example 8 provides the adjustable stopper assembly of any one of examples 1-7, in which the slider includes flanges on sides thereof and in which when the lever is in the closed position, top surfaces of the flanges contact bottom surfaces of inwardly projecting flanges disposed on opposite sides of the aircraft track.

Example 9 provides the adjustable stopper assembly of example 8, in which when the lever is in the open position, twisting the lever approximately 90 degrees around a longitudinal axis thereof releases the slider from the aircraft track by disengaging the flanges of the slider from the flanges of the aircraft track.

Example 10 provides an adjustable stopper assembly for an aircraft track, the adjustable stopper assembly including an interior portion including flanges along opposite side edges thereof, the interior portion configured to be placed in a selected location along the aircraft track; an upper portion enclosing a majority of a top surface of interior portion leaving flanges exposed; and elements for securing the interior portion to the upper portion when the interior portion is positioned in the selected location along the aircraft track, in which the securing causes top surfaces of the flanges of the interior portion to engage bottom sides of corresponding flanges of the aircraft track.

Example 11 provides the adjustable stopper assembly of example 10, in which a top surface of the adjustable stopper assembly is flush with a top of the aircraft track when the adjustable stopper assembly is secured within the aircraft track.

Example 12 provides the adjustable stopper assembly of example 10 or 11, in which the securing elements include screws, in which the screws are disposed through corresponding holes provided in the interior portion and the upper portion.

Example 13 provides the adjustable stopper assembly of any one of examples 10-12, in which loads applied to the adjustable stopper assembly are not absorbed by engagement of the top surfaces of the flanges of the interior portion with bottom surfaces of the corresponding flanges of the aircraft track.

Example 14 provides the adjustable stopper assembly of example 13, in which loads applied to the adjustable stopper assembly are absorbed through contact of outer surfaces of the upper portion with interior surfaces of portions of the aircraft track.

Example 15 provides an aircraft including a utility track, the utility track having associated therewith an adjustable stopper assembly for securing a seat at a position along the utility track, the adjustable stopper assembly including a stopper element; a slider positioned below the stopper element and having a lug on a top surface thereof that extends through the stopper element; and a lever including a pair of lugs straddling the lug of the slider, the lever connected to the slider via a spring pin through corresponding holes in the lugs and rotatable relative to a top of the stopper element between an open position in which the lever extends substantially perpendicularly to the top of the stopper element and a closed position in which the lever extends substantially parallel to top of the stopper element; in which positioning the lever in the closed position locks the slider into place within the utility track.

Example 16 provides the aircraft of example 15, in which the lever includes a handle on an end of the lever opposite the lugs thereof.

Example 17 provides the aircraft of example 15 or 16, in which distal ends of the lugs of the lever are configured to operate as cams for locking the lever in the closed position.

Example 18 provides the aircraft of any one of examples 15-17, in which the stopper element includes a recess on the top surface thereof for accommodating a portion of the lever when the lever is in the closed position such that a top surface of the adjustable stopper assembly is substantially flush with a top of the utility track.

Example 19 provides the aircraft of any one of examples 15-18, in which the slider includes flanges on side surfaces thereof and in which when the lever is in the closed position, top surfaces of the flanges contact bottom surfaces of inwardly projecting flanges disposed on opposite sides of the utility track.

Example 20 provides the aircraft of example 19, in which when the lever is in the open position, twisting the lever approximately 90 degrees about a longitudinal axis thereof releases the slider from the utility track by disengaging the flanges of the slider from the flanges of the utility track.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl +k * (Ru-Rl), wherein k is a variable ranging from 1 percent to 100 percent with a 1 percent increment, i.e., k is 1 percent, 2 percent, 3 percent, 4 percent, 5 percent,…50 percent, 51 percent, 52 percent,…, 95 percent, 96 percent, 95 percent, 98 percent, 99 percent, or 100 percent. Moreover, any numerical range defined by two R numbers as defined in the above is also specifically disclosed. Use of the term "optionally" with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C. The terms “substantially,” “close,” “approximately,” “near,” and “about,” generally refer to being within +/- 5-20% of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value based on the context of a particular value as described herein or as known in the art.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words "means for" or "step for" are specifically used in the particular claims; and (b) does not intend, by any statement in the specification, to limit this disclosure in any way that is not otherwise reflected in the appended claims.

What is claimed is:

1. An adjustable stopper assembly for an aircraft track, the adjustable stopper assembly comprising:
a stopper element having an opening therethrough;
a slider positioned below the stopper element, the slider having a lug extending through the opening in the stopper element; and
a lever positioned over the stopper element, the lever hingedly connected to the lug of the slider and configured to be rotated relative to a top of the stopper element between an open position in which the lever extends substantially perpendicularly to the top of the stopper element and a closed position in which the lever extends substantially parallel to top of the stopper element;
wherein positioning the lever in the closed position locks the slider into place relative to the aircraft track.

2. The adjustable stopper assembly of claim 1, wherein the lever comprises a pair of lugs provided on one end thereof configured to straddle the lug of the slider.

3. The adjustable stopper assembly of claim 2, wherein the lugs have holes therethrough for receiving a spring pin.

4. The adjustable stopper assembly of claim 2 wherein the lever includes a handle on an end of the lever opposite the lugs thereof.

5. The adjustable stopper assembly of claim 2, wherein distal ends of the lugs of the lever are configured to operate as cams for locking the lever in the closed position.

6. The adjustable stopper assembly of claim 1, wherein the stopper element includes a recess for accommodating a portion of the lever when the lever is in the closed position.

7. The adjustable stopper assembly of claim 6, wherein a top surface of the adjustable stopper assembly is substantially flush with a top of the aircraft track.

8. The adjustable stopper assembly of claim 1, wherein the slider comprises flanges on sides thereof and wherein when the lever is in the closed position, top surfaces of the flanges contact bottom surfaces of inwardly projecting flanges disposed on opposite sides of the aircraft track.

9. The adjustable stopper assembly of claim 8, wherein when the lever is in the open position, twisting the lever approximately 90 degrees around a longitudinal axis thereof releases the slider from the aircraft track by disengaging the flanges of the slider from the flanges of the aircraft track.

10. An adjustable stopper assembly for an aircraft track, the adjustable stopper assembly comprising:
an interior portion comprising flanges along opposite side edges thereof, the interior portion configured to be placed in a selected location along the aircraft track;
an upper portion enclosing a majority of a top surface of interior portion leaving flanges exposed; and
elements for securing the interior portion to the upper portion when the interior portion is positioned in the selected location along the aircraft track, wherein the securing causes top surfaces of the flanges of the interior portion to engage bottom sides of corresponding flanges of the aircraft track.

11. The adjustable stopper assembly of claim 10, wherein a top surface of the adjustable stopper assembly is flush with a top of the aircraft track when the adjustable stopper assembly is secured within the aircraft track.

12. The adjustable stopper assembly of claim 10, wherein the securing elements comprise screws, wherein the screws are disposed through corresponding holes provided in the interior portion and the upper portion.

13. The adjustable stopper assembly of claim 10, wherein loads applied to the adjustable stopper assembly are not absorbed by engagement of the top surfaces of the flanges of the interior portion with bottom surfaces of the corresponding flanges of the aircraft track.

14. The adjustable stopper assembly of claim 13, wherein loads applied to the adjustable stopper assembly are absorbed through contact of outer surfaces of the upper portion with interior surfaces of portions of the aircraft track.

15. An aircraft including a utility track, the utility track having associated therewith an adjustable stopper assembly for securing a seat at a position along the utility track, the adjustable stopper assembly comprising:
a stopper element;
a slider positioned below the stopper element and having a lug on a top surface thereof that extends through the stopper element; and
a lever comprising a pair of lugs straddling the lug of the slider, the lever connected to the slider via a spring pin through corresponding holes in the lugs and rotatable relative to a top of the stopper element between an open position in which the lever extends substantially perpendicularly to the top of the stopper element and a closed position in which the lever extends substantially parallel to top of the stopper element;
wherein positioning the lever in the closed position locks the slider into place within the utility track.

16. The aircraft of claim 15, wherein the lever includes a handle on an end of the lever opposite the lugs thereof.

17. The aircraft of claim 15, wherein distal ends of the lugs of the lever are configured to operate as cams for locking the lever in the closed position.

18. The aircraft of claim 15, wherein the stopper element includes a recess on the top surface thereof for accommodating a portion of the lever when the lever is in the closed position such that a top surface of the adjustable stopper assembly is substantially flush with a top of the utility track.

19. The aircraft of claim 15, wherein the slider comprises flanges on side surfaces thereof and wherein when the lever is in the closed position, top surfaces of the flanges contact bottom surfaces of inwardly projecting flanges disposed on opposite sides of the utility track.

20. The aircraft of claim 19, wherein when the lever is in the open position, twisting the lever approximately 90 degrees about a longitudinal axis thereof releases the slider from the utility track by disengaging the flanges of the slider from the flanges of the utility track.
